(19) United States
(12) Patent Application Publication
(10) Pub. No.: US 2014/0044434 A1
(43) Pub. Date: Feb. 13, 2014

(54) TRANSMITTER, RECEIVER, TRANSMISSION METHOD, RECEPTION METHOD AND COMMUNICATION SYSTEM

(71) Applicant: Yoichi Hashimoto, Tokyo (JP)

(72) Inventor: Yoichi Hashimoto, Tokyo (JP)

(73) Assignee: NEC Corporation, Tokyo (JP)

(21) Appl. No.: 14/006,684

(22) PCT Filed: Mar. 23, 2012
(86) PCT No.: PCT/JP2012/002049

§ 371 Date: Oct. 31, 2013

(30) Foreign Application Priority Data
Mar. 25, 2011 (JP) 2011-067698

(51) Int. Cl. H04B 10/118

(52) U.S. Cl. CPC H04B 10/118
USPC 398/125

(57) ABSTRACT

A transmitter includes an optical data modulation unit which modulates an optical carrier having a first frequency with a data signal and outputs the optical carrier as a signal light, an optical frequency shift unit which shifts and outputs the frequency of the signal light from the first frequency to a second frequency based on a predetermined frequency offset amount, and a frequency offset control unit which controls the frequency offset amount such that a harmonic component generated in the optical frequency shift unit does not overlap with a band of the data signal.

### TECHNICAL FIELD

The present invention relates to a transmitter, a receiver, a transmission method, a reception method and a communication system. In particular, the present invention relates to an optical transmitter, an optical receiver, an optical transmission method, an optical reception method and an optical communication system which are used in a coherent optical communication method.

### BACKGROUND ART

Recently, as an optical communication technology of the next generation on land or under the sea that uses an optical fiber network, a digital coherent optical communication method, in which a coherent optical transceiving method and a digital signal processing technology are combined, has been attracting attention.

In addition, even in a next generation free-space optical communication which connects a flying object (mobile object), such as a satellite, with a terrestrial base station and the like, the introduction of digital coherent optical communication system has begun to be studied with expectations of high sensitivity and high bit-rate.

The receiver used in the digital coherent optical communication method mixes the received signal light (received light) with the output light from a local oscillator (local oscillating light) to generate a baseband electrical signal from which the intensity and phase information of the received light can be extracted. Then, the receiver converts a signal, which have been converted into an electrical signal, into a digital signal using an analog to digital converter (ADC). Further, the receiver extracts the intensity and the phase information from the converted digital signal and performs digital signal processing on the extracted signal, and thereby demodulates data from the received signal.

FIG. 9 is a diagram illustrating a relationship among frequencies of transmitted signal light, received signal light, and local oscillating light when the signal light is coherently detected in a digital coherent optical communication method that uses an optical fiber as a transmission medium. In FIG. 9, the frequencies of the transmitted signal light and the received signal light are fs, and the frequency of the local oscillating light is fLO.

In the digital coherent optical communication method shown in FIG. 9, an intradyne method is applied which approximately matches the frequency of the received signal light and the frequency of the local oscillating light. In the method, frequency synchronization and phase synchronization between a received optical signal and the local oscillating light are not performed in the state of the optical signal. A frequency shift and a phase shift of the received signal and the local oscillating light are compensated as an electrical signal using digital signal processing technology.

In the receiver, it is preferable that the amount of the frequency shift of the received light and the local oscillating light is, for example, within a few GHz. The receiver performs the frequency synchronization and the phase synchronization by performing the phase synchronization processing in the digital signal processing. For this reason, more specifically, it is preferable that the amount of the frequency shift of the received light and the local oscillating light is within the range of frequency synchronization of the phase synchronization processing of the receiver. At present, the error of the oscillation frequency of the laser that is commercially used is about ±2.0 GHz. If it is considered that two light sources, the light source on the transmission side and the local oscillating light source on the receiving side, are used in an actual optical communication system, the amount of frequency shift may become ±5.0 GHz or more. The receiver compensates the frequency shift with the digital signal processing.

FIG. 10 is a diagram illustrating a configuration with which the frequency synchronization and the phase synchronization of the received light and the local oscillating light are performed, which configuration is described in non-patent document 1. Non-patent document 1 discloses a configuration which makes the frequency difference between the received light and the local oscillating light equal to or less than a few GHz, and thereby stably performs the phase compensation by the digital signal processing.

In the configuration shown in FIG. 10, the signal light and the output of the optical frequency shifter unit 1206 are input into a 90° hybrid 1201. Then, the 90° hybrid 1201 outputs an I (inphase) signal and a Q (quadrature) signal that are orthogonal to each other. Samplers 1202 and 1203 perform a sampling on the I signal and the Q signal, and input them into a carrier phase extraction unit 1204. The carrier phase extraction unit 1204 detects the frequency difference between the output light of the local oscillating light source 1208 and the signal light. Then, the carrier phase extraction unit 1204 controls a voltage controlled oscillator (VCO) 1207 with the signal indicating the detected frequency difference. The VCO 1207 generates a signal having the frequency corresponding to the frequency difference that the carrier phase extraction unit 1204 detects. Further, the optical frequency shifter unit 1206 shifts the frequency of the local oscillating light source 1208 that is input into the 90° hybrid 1201 with the signal that the VCO 1207 generates.

On the other hand, in the free-space optical communication system between the mobile object and the terrestrial base station or between the mobile objects, the dynamic shift (frequency shift) of the carrier frequency of the signal light may occur in a channel. If a digital coherent optical transceiving method is applied to such a communication system, the frequency shift occurs in the channel, and therefore the frequency offset may occur beyond the frequency difference that can be compensated in the digital signal processing.

In particular, if drastically large frequency shift (for example, in a case of QPSK, the phase shift close to □/2) occurs, it is difficult to distinguish whether the phase difference between the symbols of the received signals is a symbol transition due to the modulation or is the frequency difference from the local oscillating light. As a result, the stable modulation in the digital signal processing circuit may not be realized in a state where there is such frequency shift.

Further, in a case where the frequency offset dynamically changes, when performing the frequency compensation and the phase compensation with the digital signal processing, the dynamically changing amount of the frequency compensation amount may become large. In such a case, there is a problem that the error of the phase compensation may easily occur, and thus an error may occur in determination of the signal to be demodulated, in the digital signal processing circuit.

Further, a high speed oversampling is performed in the frequency compensation, and thus it is possible to improve the compensation accuracy in the frequency compensation amount. However, if the oversampling is performed, the amount of data to be processed per unit time increases, and thus there is a problem that the size of the signal processing circuit becomes large.

The above problems will be described in detail using FIG. 11. FIG. 11 is a diagram illustrating the frequencies of the transmitted signal light, the received signal light and the local oscillating light, in a case where the digital coherent optical transceiving method is introduced to the free-space optical communication channel.

Referring to FIG. 11, in a free-space optical communication, the frequency of the signal light (fs) transmitted from the mobile object such as a satellite has a positive or negative frequency shift (+Δf or −Δf), depending on the relative moving speed between the mobile object and the earth station. The cause for the occurrence of the frequency shift is, for example, Doppler shift.

In particular, at the start of transmission of the mobile object (A), the mobile object moves toward the earth station. For this reason, the earth station receives the signal light of which frequency is fs+Δf from the mobile object. Then, the speed of the mobile object relative to the earth station becomes low as the mobile object approaches the apex (B), and thus the frequency shift Δf becomes close to zero. At the moment when the mobile object passes through the apex (B), the earth station receives the signal having the same frequency as the transmitted light.

The mobile object moves away from the earth station after passing through the apex (B). For this reason, the earth station receives the signal of which frequency is fs−Δf. In general, the frequency f can be denoted as f=c/λ using the light speed c and the wavelength λ. Therefore, the wavelength of the signal light that the earth station receives is shifted to the shorter wavelength side than λs (=c/fs), from immediately after the transmission start time until when the mobile object reaches the apex (B). Then, the wavelength of the signal light that the earth station receives is shifted to the longer wavelength side than λs from after the mobile object passes through the apex (B) until the end of the transmission.

The frequency shift amount Δf reaches ±10 GHz or more in a high speed mobile object such as a low earth orbit (LEO) satellite. For this reason, the optical frequency difference between the frequency of the signal light that is received in the terrestrial base station and the frequency fLO of the local oscillating light may increase along with time.

In a case where there is Doppler shift, large frequency difference occurs due to the frequency shift, in addition to the optical frequency difference between the local oscillating light and an optical carrier due to the fluctuation of the frequency of the local oscillating light, which fluctuation is expected in intra-dyne detection of the self-running local oscillating light and the optical carrier. Further, since the frequency shift amount varies along with the position of the mobile object, the frequency of the optical carrier greatly varies along with time. This means that estimation of the dynamic carrier frequency is necessary.

With respect to the present invention, Patent Document 1 and Patent Document 2 disclose a wireless transmission system or a wireless communication system which adjusts the carrier frequency based on the Doppler shift amount between the mobile object and the earth station. Further, Patent Document 3 discloses a configuration in which the coherent optical communication system is applied to the free-space optical transmission apparatus.

### RELATED DOCUMENT

### Patent Document

[Patent Document 1] Japanese Unexamined Patent Application Publication No 2006-345427
[Patent Document 2] Japanese Unexamined Patent Application Publication No. 2009-201143
[Patent Document 3] Japanese Unexamined Patent Application Publication No. 6-112904

### Non-Patent Document

[Non-Patent Document 1] Sakamoto et al., “Digital Optical Cost as Loop for Coherent Demodulation of 10-Gb/s BPSK”, the 15th OptoElectronics and Communication Conference (OECC2010), June, 2010, 9B3-2

### DISCLOSURE OF THE INVENTION

In a case of performing a frequency shift using an optical frequency shifter unit 1206 shown in FIG. 10, a high order sideband (harmonic) is generated. For example, suppose that the frequency of the local oscillating light is shifted with an optical single sideband modulator. In this case, if Δf, the absolute value of the shift amount of the frequency in the optical frequency shifter unit, is small, a data signal component and a data modulation component superimposed on a harmonic may be overlapped. In the case, there is a problem that the data signal component and the harmonic component cannot be separated.

FIG. 12 is a diagram illustrating an example of a configuration of the optical frequency shifter unit. An optical frequency shifter unit 1101 shown in FIG. 12 includes a VCO 1102 and two MZMs (Mach-Zehnder Modulator) 1103 and 1104.

The VCO 1102 generates a signal, frequency of which is Δf and corresponds to the frequency shift amount, with the signal that is input from the outside, and applies the signal to two MZMs 1103 and 1104. This enables to shift the signal carrier frequency of the optical signal input to the MZM by Δf. Here, since the optical frequency shifter configured with the MZMs has been known to those skilled in the art, the detailed description thereof is omitted.

FIG. 13 is a diagram illustrating a general relationship between the frequency component of the signal light after shifting the frequency of the signal light with the optical frequency shifter unit 1101 described in FIG. 12 and the frequency component of the third order harmonic generated additionally. FIG. 13(a) is a spectrum of the signal light to be input to the optical frequency shifter unit 1101, and FIG. 13(b) is a spectrum of the signal light to be output from the optical frequency shifter unit 1101.

As shown in FIG. 13(b), in a case where the absolute value If of the shift amount in the optical frequency shifter unit is relatively small, the bands of the data signal component and data modulation component superimposed on the harmonic may be overlapped. As a result, it is not possible to separate the data signal component and the harmonic. For example, in a case where the frequency shift amount varies from a positive value to zero and varies from zero to a negative value, in the signal light that is output from the optical frequency shifter unit 1101, the smaller the absolute value of the shifted frequency is, the stronger the interference (beat) generated between the signal light and the harmonic component becomes. Then, an interference component is superimposed on the signal light, and whereby the signal to noise ratio of the signal light is worsened. As a result, the demodulation of data is not correctly performed, and thus a problem in which the communication quality of the communication system is deteriorated occurs.

However, the aforementioned non-patent document 1 and the patent documents 1 to 3 do not solve the problem, in which the communication quality of the communication system is deteriorated since the harmonic of the light output from the optical frequency shifter unit overlaps with the band of the data signal.

The object of the present invention is to provide a technology in order to solve the problem, in which the communication quality of the communication system is deteriorated since the harmonic of the light that is output from the optical frequency shifter unit overlaps with the hand of the data signal and thus the signal to noise ratio of the signal light is worsened.

A transmitter of the present invention includes an optical data modulation unit which modulates an optical carrier having a first frequency with a data signal and outputs the optical carrier as signal light; an optical frequency shift unit which shifts and outputs the frequency of the signal light from the first frequency to a second frequency based on a predetermined frequency offset amount; and a frequency offset control unit which controls the frequency offset amount such that a harmonic component generated in the optical frequency shift unit does not overlap with a band of the data signal.

A receiver of the present invention includes a receiving unit which receives the signal light having a second frequency; an optical frequency shift unit which shifts and outputs the frequency of local oscillating light having a third frequency to the second frequency based on a predetermined frequency offset amount; a frequency offset control unit which controls the frequency offset amount such that a harmonic component generated in the optical frequency shift unit does not overlap with a band of the data signal; and a coherent receiving unit which performs coherent reception using the signal light and the local oscillating light output from the frequency shift unit.

A transmission method of the present invention includes modulating an optical carrier having a first frequency with a data signal and outputting the optical carrier as a signal light; shifting and outputting the frequency of the signal light from the first frequency to a second frequency based on a predetermined frequency offset amount; and controlling the frequency offset amount such that a harmonic component generated at the time of shift to the second frequency does not overlap with a band of the data signal.

A reception method of the present invention includes receiving signal light having a second frequency, that is modulated with a data signal; shifting and outputting the frequency of a local oscillating light having a third frequency to the second frequency based on a predetermined frequency offset amount, controlling the frequency offset amount such that a harmonic component generated at the time of shift to the second frequency does not overlap with a band of the data signal; and performing coherent reception using the signal light and the local oscillating light shifted to the second frequency.

The present invention shows an effect of improving a communication quality in a communication system.

### BRIEF DESCRIPTION OF THE DRAWINGS

The aforementioned object, and other objects, features and advantages will be more apparent from proper exemplary embodiments described below, and the accompanying drawings below.

FIG. 1 is a diagram illustrating a basic configuration of a first exemplary embodiment.

FIG. 2 is a diagram illustrating a frequency of light that is output from an optical frequency shifter unit in the first exemplary embodiment.

FIG. 3 is a diagram illustrating a configuration of an optical communication system of the first exemplary embodiment.

FIG. 4 is a diagram illustrating a configuration of the optical communication system, of a second exemplary embodiment.

FIG. 5 is a diagram illustrating a relationship between a frequency of a transmitted optical signal and a frequency of local oscillating light in the second exemplary embodiment.

FIG. 6 is a diagram illustrating a configuration of the optical communication system of a third exemplary embodiment.

FIG. 7 is a diagram illustrating a configuration of an emulation system of a fourth exemplary embodiment.

FIG. 8 is a diagram illustrating a handover of communication between a satellite and an earth station, as a fifth exemplary embodiment.

FIG. 9 is a diagram illustrating frequencies of transmitted signal light, received signal light and local oscillating light in a digital coherent optical communication method which uses an optical fiber as a transmission medium.

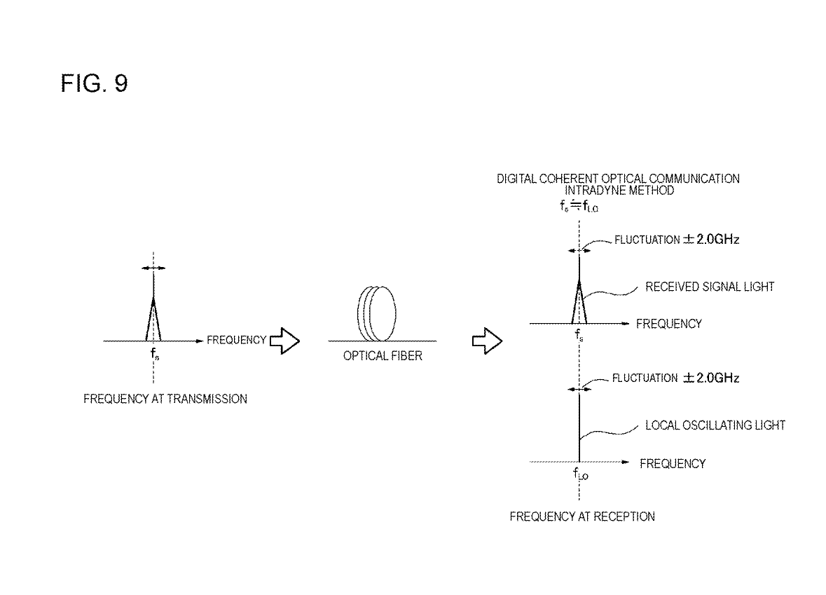

FIG. 10 is a diagram illustrating a method of performing frequency synchronization and phase synchronization of the optical signal and the local oscillating light, related to the present invention.

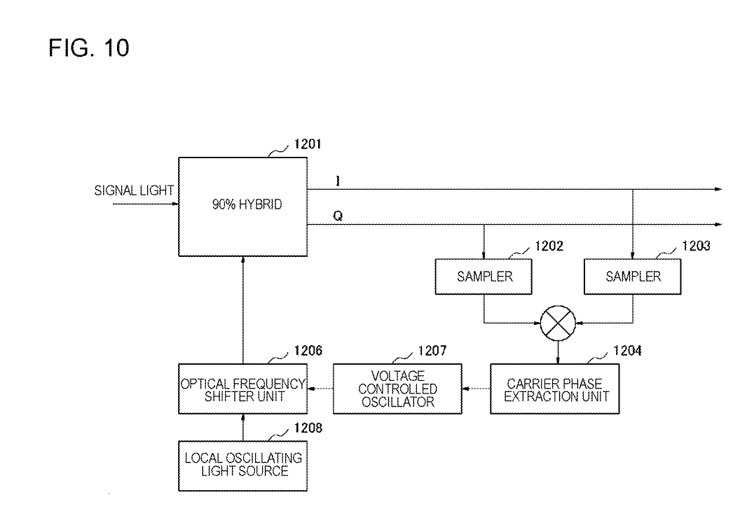

FIG. 11 is a diagram illustrating the frequencies of the transmitted signal light, the received signal light and the local oscillating light, in a case where the digital coherent optical transceiving method is introduced to a free-space optical communication channel.

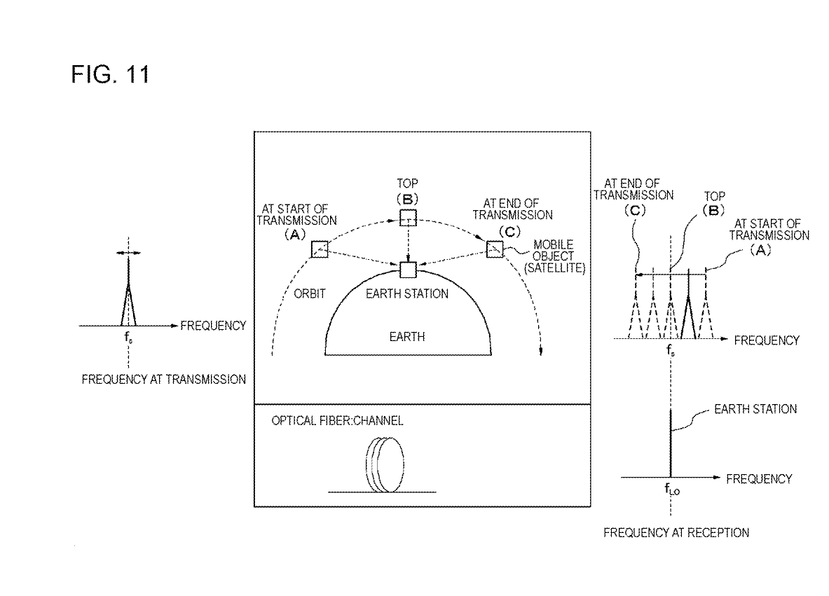

FIG. 12 is a diagram illustrating an example configuration of an optical frequency shifter unit.

FIG. 13 is a diagram illustrating a relationship between signal light generated after shifting the signal light with the optical frequency shifter unit and a harmonic component generated additionally.

### DESCRIPTION OF EMBODIMENTS

Next, a detail description of the exemplary embodiments of the present invention will be described referring to the drawings. However, the exemplary embodiments described below are merely examples in a free-space optical communication. That is, the exemplary embodiments below can be generally applied to a case where the frequency of an optical signal is shifted when the signal is transmitted over a channel. Further, the following description is not intended to exclude applications of various modifications and technologies not clearly described. That is, the exemplary embodiments below can be modified and implemented within the scope without departing from the spirit.

### First Exemplary Embodiment

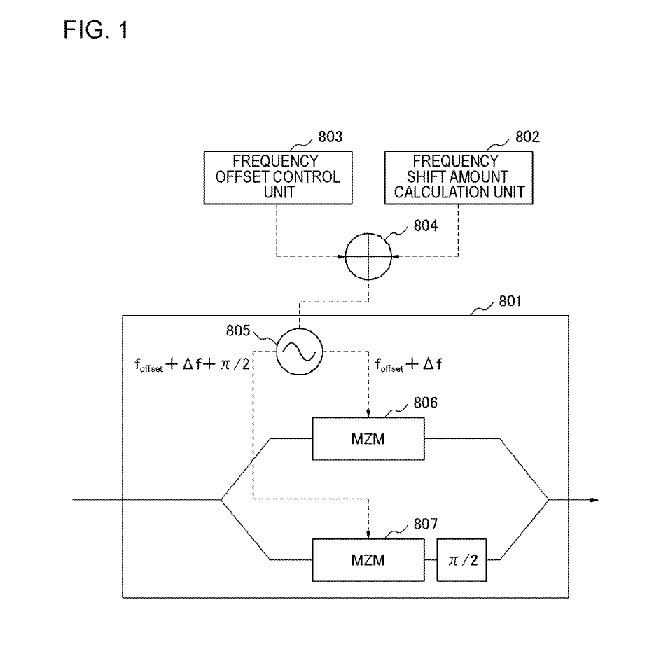

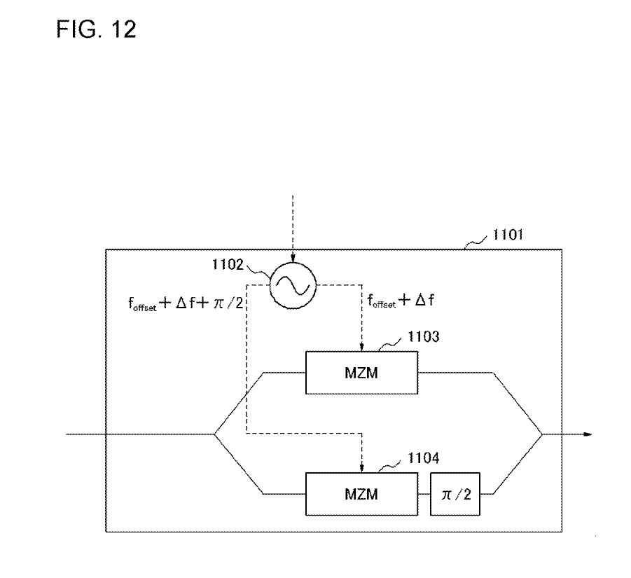

FIG. 1 is a diagram illustrating of a configuration of a first exemplary embodiment of the present invention. An optical frequency shifter unit 801 gives a frequency shift corresponding to the input signal to the input signal light to be output. The optical frequency shifter unit 801 is configured with, for example, a single sideband modulator. Further, the optical frequency shifter unit that is described in FIG. 12 may be used as the optical frequency shifter unit 801.

A frequency shift amount calculation unit 802 outputs a signal corresponding to a signal carrier frequency shift amount Δf. Here, the signal carrier frequency shift amount Δf is the absolute value of a frequency shift amount that the signal light is given during propagation on a transmission path. The frequency offset control unit 803 outputs a signal corresponding to the frequency offset amount foffset. Based on the signals, the frequency applying unit 804 outputs a signal indicating the frequency of foffset±Δf to a VCO 805 included in the optical frequency shifter unit 801.

Note that, “±Δf” indicates that the actually shifted frequency is either +Δf or −Δf depending on a case. The VCO 805 generates a signal of which frequency is foffset±Δf, based on the signal indicating the frequency of foffset±Δf that is input from the frequency applying unit 804.

For example, each of the frequency shift amount calculation unit 802 and the frequency offset control unit 803 may output a direct voltage in proportion to the frequency. Then, the frequency applying unit 804 sums the direct voltages and output the summed one to the VCO 805, and VCO 805 may generate a signal of the frequency in proportion to the direct voltage that is input from the frequency applying unit 804. Here, the frequency applying unit 804 substrates the direct voltage indicating the frequency shift amount Δf in a case where the frequency of the signal light is shifted in the direction that the frequency is decreased by Δf.

The optical frequency shifter unit 801 applies the signal, which JCO 805 generates and of which frequency is foffset±Δf, to a MZMs 806 and 807, and thus shifts the frequency of the signal light to be input by the frequency that the signal carrier frequency shift amount Δf is added to or subtracted from the frequency offset amount foffset.

For example, in a case where foffset±Δf is a positive value, the optical frequency shifter unit 801 shifts the frequency of the input signal light to the side of higher frequency. In contrast, in a case where foffset±Δf is a negative value, the optical frequency shifter unit 801 shifts the frequency of the input signal light to the side of lower frequency.

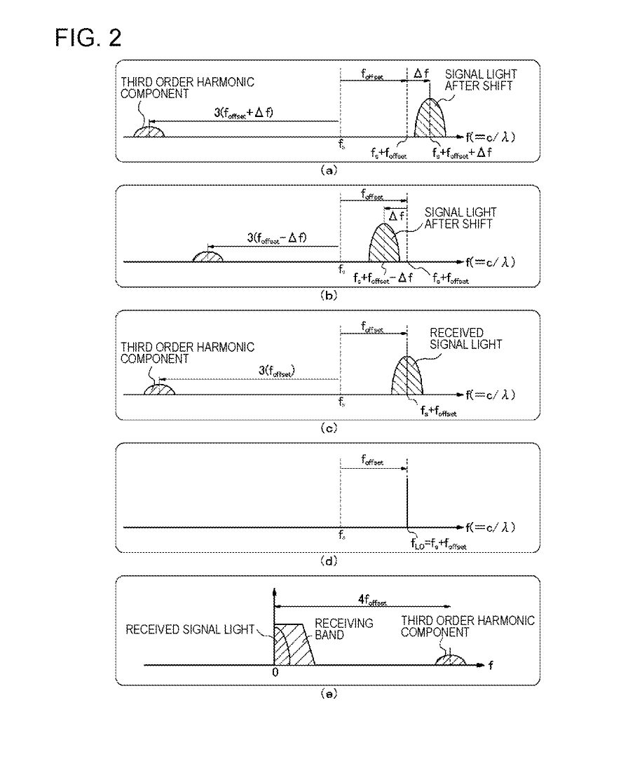

FIG. 2 is a diagram illustrating the frequency of the light that is output from the optical frequency shifter unit 801. FIG. 2 shows a relationship between the signal light generated after shifting the signal light with the optical frequency shifter unit and the frequency of a high order (in FIG. 2, third order) harmonic component that is additionally generated.

Referring to FIG. 2, the operation of the optical frequency shifter unit 801 is described. FIG. 2(a) shows a case of performing a shift by the signal carrier frequency shift amount Δf to the side where the frequency of the signal light increases. FIG. 2(b) shows a case of performing a shift by the signal carrier frequency shift amount Δf to the side where the frequency of the signal light decreases. As shown in FIG. 2(a) and FIG. 2(b), the optical frequency shifter unit 801 shifts the frequency of the optical signal of which frequency is fs by the shift amount foffset±Δf, which is sum of the frequency amount Δf estimated so as to correct the signal carrier frequency shift and the frequency offset amount foffset. Here, Δf is set to have the same absolute value as the signal carrier frequency shift that the signal light actually receives, but to have an opposite sign therefrom. Then, the optical frequency shifter unit 801 outputs the signal light having the frequency of fs+foffset+Δf or fs+foffset−Δf. In this case, in the optical frequency shifter unit 801, a third order harmonic having the frequency 3×(foffset±Δf) is also generated.

If each of the signal light shown in FIG. 2(a) and FIG. 2(b) is propagated through the channel, in which the dynamic shift −Δf or +Δf of the signal carrier frequency is generated, as shown in FIG. 2(c), the signal carrier frequency shifts ±Δf are cancelled. As a result, the signal light of which frequency is (fs+foffset) reaches the receiver.

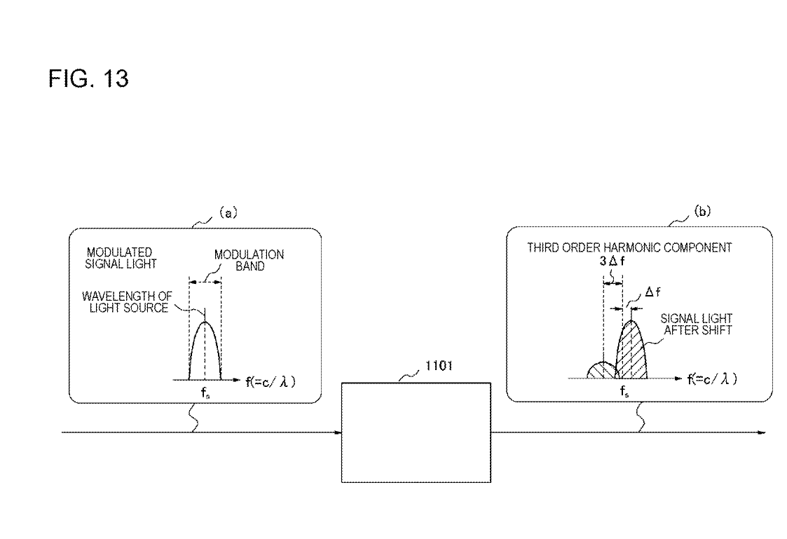

On the other hand, as shown in FIG. 2(d), the receiver sets such that the frequency of the local oscillating light becomes fs+foffset. As shown in FIG. 2(e), the signal light to be received and the third order harmonic are converted into a baseband modulation signal based on fs+foffset with the local oscillating light and the intradyne detection. At this time, as described in FIG. 13, if the frequency offset amount foffset (in FIG. 13, denoted as Δf) is small, the bands of data signal component and the data modulation component that is superimposed on the harmonic may be overlapped.

In the first exemplary embodiment, the frequency offset amount foffset is therefore set such that third order harmonic component generated in the optical frequency shifter unit (for example, in a case of FIG. 2(d), the frequency generated in 4×(foffset±Δf)) does not overlap with the band of the data demodulated from the signal light.

Referring to FIG. 2(d), the data which is demodulated from the received signal light and of which the total width of the band is W occupies the band of 0 to W/2 in the baseband frequency region. On the other hand, the central frequency of the third order harmonic component is on a position of 4×foffset on the frequency axis, and the band width (total width) thereof is W. Accordingly, in order that the data signal and the third order harmonic do not to overlap with each other, foffset may be set within the band of 4×foffset such that the band (half width) W/2 of the demodulated data and the band (half width) of the third order harmonic do not overlap. That condition is obtained as foffset>W/4, by 4×foffset>W/2+W/2. That is, when describing the band width (total width) of the data signal as W, if foffset is set to the frequency of W/4 or more, the third order harmonic component that is generated in the optical frequency shifter unit and the frequency component of the data signal do not overlap.

In the first exemplary embodiment, the frequency offset amount foffset is set to be larger than the total width W of the signal band in the receiver. Accordingly, the frequency generated in the third order harmonic component, which is generated in the optical frequency shifter unit, is eliminated.

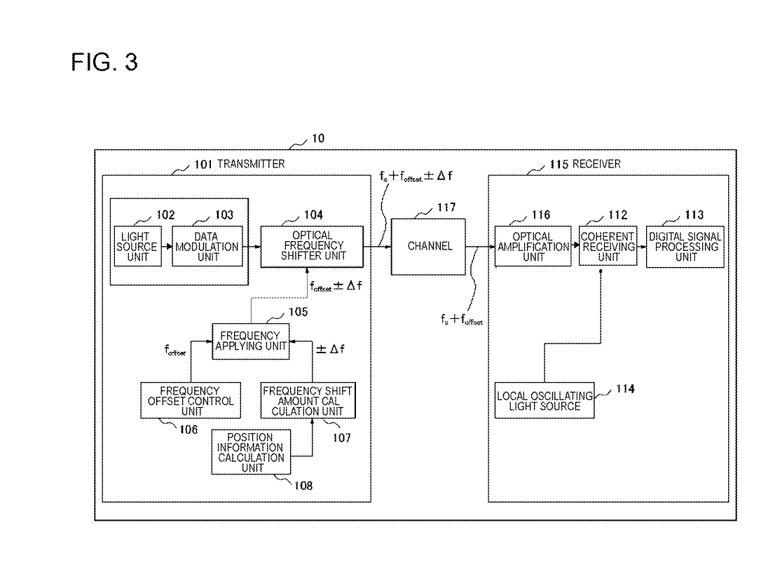

FIG. 3 is a diagram illustrating a configuration of the optical communication system of the first exemplary embodiment of the present invention. The optical communication system 10 connects the satellite, which is a flying object, and the earth station though a free-space optical communication. The satellite moves relative to the earth station, and the relative distance between the satellite and the earth station changes with time. In the case described below, the transmitter 101 is installed in the satellite and the receiver 115 is installed in the earth station will be described.

The digital coherent optical communication method is applied to the optical communication system 10. The signal light data transmitted from the transmitter 101 that is installed in the satellite is received in the receiver 115 installed in the earth station through the channel 117 in which the dynamic shift of the signal carrier frequency occurs by a free-space optical communication.

In FIG. 3, the transmitter 101 includes a light source unit 102, a data modulation unit 103, an optical frequency shifter unit 104, a frequency applying unit 105, a frequency offset control unit 106, a frequency shift amount calculation unit 107, and a position information calculation unit 108. Further, the receiver 115 includes an optical amplification unit 116, a coherent receiving unit 112, a digital signal processing unit 113, and a local oscillating light source 114.

The position information calculation unit 108 outputs, to the frequency shift amount calculation unit 107, the distance between the satellite and the earth station, the positions thereof, or information related to the moving speed of the satellite. The position information calculation unit 108 calculates, for example, the moving speed based on the change amount of the position per unit time.

The frequency shift amount calculation unit 107 calculates the frequency shift amount Δf that the signal light, which is output from the transmitter, is given until it reaches the earth station. The frequency shift amount Δf is, for example, the frequency shift amount caused due to Doppler shift and the like, and it is able to be calculated using the change in the distance between the satellite and the earth station, the change in the position thereof, the information related to the moving speed of the satellite, or the like. Then, the frequency shift amount calculation unit 107 generates the signal corresponding to the frequency of which sign is opposite to the frequency shift amount received when propagating, with respect to the calculated frequency shift amount Δf. In general, in a case where the satellite approaches the earth station, the wavelength of the signal light emitted from the transmitter is shifted toward the side of +Δf in which the frequency increases (the short wavelength side in terms of the wavelength). In contrast, in a case where the satellite moves away from the earth station, the frequency is shifted toward the side of −Δf in which the frequency decreases (the long wavelength side in terms of the wavelength). For this reason, the frequency of the signal, which the frequency shift amount calculation unit 107 outputs, changes toward the side in which the frequency decreases when the satellite approaches, and changes toward the side in which the frequency increases when the satellite moves away. The frequency shift amount calculation unit sequentially calculates the frequency shift amount using the position information and the speed information of the satellite from the communication start time to the communication end time.

On the other hand, the frequency offset control unit 106 takes into account each maximum value of the data modulation band of the signal light that is modulated by the data modulation unit and the frequency shift amount that is calculated by the frequency shift amount calculation unit, and generates a signal corresponding to the frequency offset foffset that is a frequency larger than the sum of those value.

For example, when transmitting an optical signal in which data modulation is performed at a data rate of 50 Gbps using a single polarization wave Quadrature Phase Shift Keying (QPSK) method, the baud rate of the transmission signal is 25 GHz. Here, suppose that the maximum frequency shift amount by the Doppler shift and the like is 10 GHz, the frequency offset control unit 106 sets the frequency offset as foffset=40 GHz so that it is equal to or larger than 25 GHz+10 GHz=35 GHz. Then, the frequency offset control unit 106 outputs a signal of which frequency is 40 GHz.

Here, “signal corresponding to the frequency” that the frequency offset control unit 106 and the frequency shift amount calculation unit 107 output may be the direct voltage in proportion to the frequency, and the frequency applying unit 105 may output the direct voltage of the sum of the direct voltages thereof.

The signal light 110, which is modulated in the data modulation unit 103 and has the wavelength λS (=c/fs), enters into the optical frequency shifter unit 104. The frequency applying unit 105 outputs a signal indicating the added frequency foffset±Δf.

The optical frequency shifter unit 104 shifts the frequency of the signal light 110 by foffset±Δf, based on the signal that is input from the frequency applying unit 105. For example, the optical frequency shifter unit 104 may shift the frequency of the signal light by causing the VCO to oscillate the frequency in proportion to the direct voltage of the signal that is input from the frequency applying unit 105, and applying the output of the VCO to the MZM. At this time, the optical frequency shifter unit 104 simultaneously outputs the optical signal 111 of which signal carrier frequency is fs+foffset±Δf (=c/(λs+λoffset±Δλ)) and the harmonic component of third order or more.

The optical signal 111 output from the optical frequency shifter unit 104 is emitted from the optical transmission antenna to the space. While the transmission signal light propagates through the channel in which the dynamic shift of the optical carrier frequency occurs, the frequency shift ±Δf is cancelled. As a result, the receiver receives the receiving light 119 of which signal light carrier frequency is fs+foffset through the optical receiving antenna.

The optical amplification unit 116 amplifies the receiving light 119. The coherent receiving unit 112 converts the received light amplified in the optical amplification unit 116 into an electrical signal using a coherent receiving technology. The coherent receiving unit 112 includes, for example, a 90° hybrid optical circuit, a balanced detector, an electric band pass filter, an analog to digital converter (ADC), and the like. The general configuration of the coherent receiving unit 112 has been known, thus a detailed description of the configuration and the operation thereof will be omitted. The coherent receiving unit 112 mixes the received light amplified in the optical amplification unit 116 with the local oscillating light output from the local oscillating light source 114 in order to demodulate the baseband modulation signal. In particular, the optical frequency fLO of the local oscillating light is set to be approximately equal to the frequency fs+foffset of the receiving light 119 that is received.

Here, if there is a big difference between the frequency fLO of the local oscillating light source 114 and the frequency fs of the light source unit 102, the compensation of the frequency difference may become difficult in the digital signal processing unit 113. For this reason, the frequency offset control unit 106 may set in advance foffset such that the frequency fs+foffset of the signal light that the receiver 115 receives is substantially equal to the frequency fLO of the local oscillating light source 114. As a result, even in a case where the frequency fLO of the local oscillating light source 114 and the frequency fs of the light source unit 102 are different, in the digital signal processing unit 113, it is possible to compensate the frequency difference between the signal light that the receiver 115 receives and the local oscillating light source 114.

Then, in the coherent receiving unit 112, the digitized modulation signal is obtained by sampling the baseband modulation signal, which is detected using the intradyne detection, using the ADC. Further, out of the data signals that are received in the receiver, the high order harmonic component outside of the receiving band of the coherent receiving unit 112 is eliminated without affecting the data signal.

The digital signal processing unit 113 performs compensation such as a waveform shaping, a phase extraction, a frequency deviation and a phase deviation on the received signal in order to demodulate data.

As described above, in the optical communication system of the first exemplary embodiment, the wavelength of the light source of the transmitter and the wavelength of the local oscillating light source of the receiver are separated away by the frequency offset amount. Then, since the frequency offset is generated such that the frequency becomes larger than the sum of the data modulation band and the frequency shift amount in the transmitter, the third order harmonic component output from the optical frequency shifter unit does not overlap with the band of the data demodulated from the signal light. As a result, in the optical communication system of the first exemplary embodiment, it is possible to reduce the deterioration in the optical signal to noise ratio due to the harmonic component generated in the optical frequency shifter unit of the transmitter.

Further, the optical communication system of the first exemplary embodiment further shifts the signal light carrier frequency in order to cancel the frequency shift generated based on the movement of the mobile object. For this reason, in the optical communication system of the first exemplary embodiment, it is possible to reduce the frequency difference between the receiving light and the local oscillating light generated based on the movement of the mobile object. As a result, in the optical communication system of the first exemplary embodiment, without performing an over sampling, it is possible to correctly detect the phase of the symbol of the receiving data.

As described above, the optical communication system of the first exemplary embodiment shows an effect of improving the communication quality of the communication system. In addition, the optical communication system of the first exemplary embodiment can further reduce the processing amount of digital signal processing in comparison with a configuration in which the phase compensation accuracy of the receiving data is improved using oversampling. As a result, the optical communication system of the first exemplary embodiment shows an effect that it is possible to reduce the size of the digital signal processing circuit and to intend to reduce the power consumption of the digital signal processing circuit of the transmitter.

Further, in the first exemplary embodiment, in a case where the band width (total width) of the data signal is set to N, the frequency offset amount may be set to W/4 or more. If the frequency offset amount is set to at least W/4 or more, the third order harmonic component generated in the optical frequency shifter unit and the frequency component of the data signal do not overlap. Accordingly, even in a case where the frequency offset amount is set to W/4 or more, the same effect as the effect of the first exemplary embodiment is achieved.

Note that, in the optical communication system shown in FIG. 3, the transmitter 101 includes only the light source unit 102, the data modulation unit 103, the optical frequency shifter unit 104 and the frequency offset control unit 106, and the output of the frequency offset control unit 106 may be directly input to the optical frequency shifter unit 104. In this case, the frequency offset control unit 106 controls the optical frequency shifter unit 104 to shift the signal light carrier frequency so as to cancel the frequency shift generated based on the movement of the mobile. As a result, even the transmitter including only the light source unit 102, the data modulation unit 103, the optical frequency shifter unit 104 and the frequency offset control unit 106 can achieve the same effect as the aforementioned effect of the first exemplary embodiment.

### Second Exemplary Embodiment

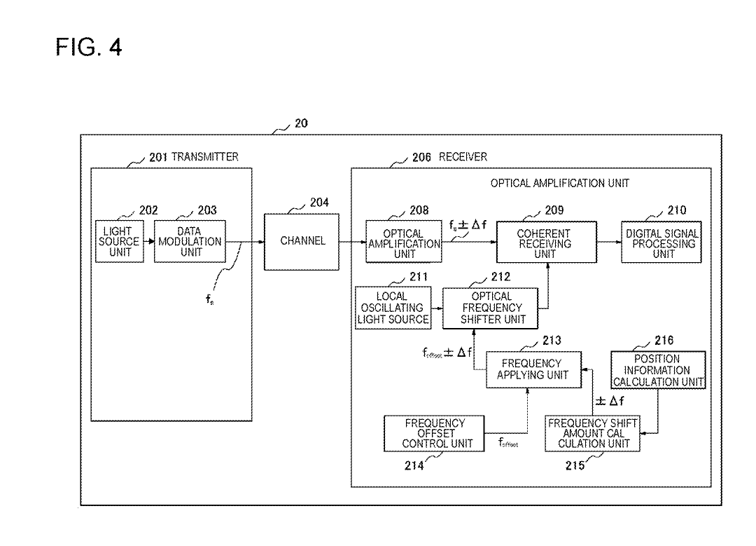

FIG. 4 is a diagram illustrating a configuration of an optical communication system of the second exemplary embodiment of the present invention. In the optical communication system 20 of the second exemplary embodiment, the signal light data transmitted from the transmitter 201 is received by the receiver 206 in which a digital coherent optical communication method is applied, through the channel 204 in which the dynamic shift of the signal carrier frequency such as a free-space optical communication occur.

The transmitter 201 includes alight source unit 202 and a data modulation unit 203. In the transmitter 201, the optical carrier of the frequency fs(=c/λS) that the light source unit 202 generates is modulated by the data modulation unit 203 and is emitted to the channel 204.

The receiver 206 includes an optical amplification unit 208, a coherent receiving unit 209, a digital signal processing unit 210, a local oscillating light source 211 and an optical frequency shifter unit 212. The receiver 206 further includes a frequency applying unit 213, a frequency offset control unit 214, a frequency shift amount calculation unit 215 and a position information calculation unit 216.

In the optical communication system 10 described in FIG. 3, the output of the data modulation unit 103 and the output of the frequency applying unit 105 are input to the optical frequency shifter unit 104 in the transmitter 101. In contrast to this, the optical communication system 20 shown in FIG. 4, the output of the local oscillating light source 211 and the output of the frequency applying unit 213 are input to the optical frequency shifter unit 212 in the receiver 206.

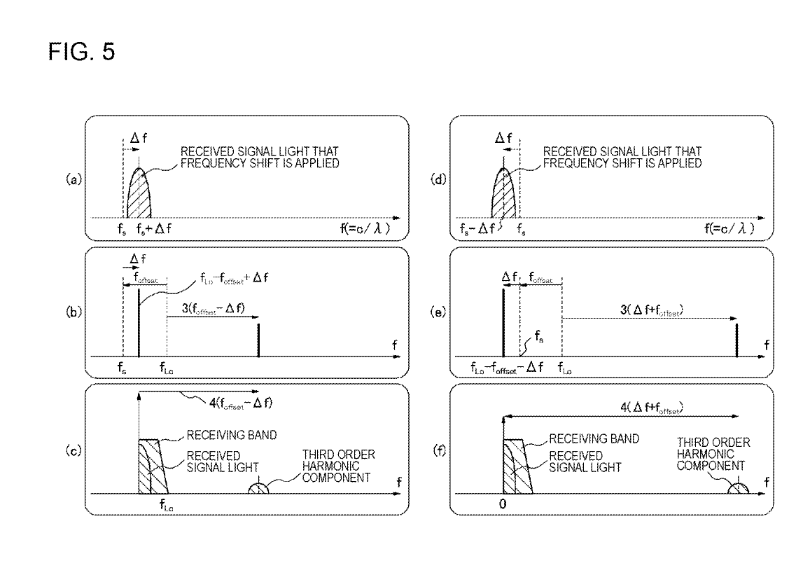

FIG. 5 is a diagram illustrating a relationship between the frequency of the transmitted optical signal and the frequency of the local oscillating light in the second exemplary embodiment.

FIG. 5(a) shows that the frequency fs of the signal light emitted from the transmitter of the satellite approaching the earth station becomes frequency fs+Δf because of being subject to a frequency shift +Δf such as Doppler shift. The receiver 206 receives the signal light being subject to a frequency shift +Δf.

FIG. 5(b) shows a situation of shifting the frequency fLO of the local oscillating light source 211 in the receiver 206 when receiving the signal light emitted from the transmitter of the satellite approaching the earth station.

Similar to the optical frequency shifter unit 104 described in FIG. 3, the optical frequency shifter unit 212 included in the receiver 206 shifts the frequency fLO of the local oscillating light source 211, based on the output of the frequency applying unit 213. The outputs of the frequency offset control unit 214 and the frequency shift amount calculation unit 215 are input to the frequency applying unit 213. Further, the output of the frequency shift amount calculation unit 215 is controlled by the position information calculation unit 216.

Then, an intradyne detection is performed on the receiving light of which frequency becomes fs+Δf by the frequency shift and the local oscillating light of the frequency fLO. For this reason, the optical frequency shifter unit 212 shifts the wavelength fLO of the local oscillating light such that the frequency of the local oscillating light input to the coherent receiving unit 209 becomes approximately equal to the frequency fs+Δf of the optical carrier of the receiving light.

The position information calculation unit 216 and the frequency shift amount calculation unit 215 have the same functions as the position information calculation unit 108 and the frequency shift amount calculation unit 107 described in FIG. 3. That is, the position information calculation unit 216 outputs the position information of the satellite and the earth station to the frequency shift amount calculation unit 215. The frequency shift amount calculation unit 215 calculates the relative speed between the satellite and the earth station, based on the position information input from the position information calculation unit 216. Then, the frequency shift amount calculation unit 215 estimates the frequency shift amount and the frequency shift direction of the received signal light at a certain time, and outputs the corresponding signal to the frequency applying unit 213.

The frequency offset control unit 214 sets a frequency offset amount foffset larger than the sum of the frequency shift amount Δf calculated by the frequency shift amount calculation unit 215 and the band of the received modulation signal, and outputs the signal corresponding to the frequency offset amount to the frequency applying unit 213.

The frequency applying unit 213 inputs the signal, corresponding to the frequency which is the sum of the frequency offset amount foffset and the frequency shift amount Δf, to the optical frequency shifter unit 212.

As shown in FIG. 5(b), the optical frequency shifter unit 212 outputs the light of which frequency is fLO −foffset+Δf and the third order harmonic of which frequency is 3 (foffset −Δf).

Here, similar to the first exemplary embodiment, the frequency offset control unit 214 and the frequency shift amount calculation unit 215 may output the direct voltage in proportion to the frequency as a “signal corresponding to the frequency.” Then, the frequency applying unit 213 may output the direct voltage of the total voltage of these direct voltages to the optical frequency shifter unit 212. Then, the optical frequency shifter unit 212 may shift the frequency of the received signal light by causing the VCO to oscillate the signal of which frequency is the sum of the frequency offset amount foffset and the frequency shift amount Δf and applying the output of the VCO to the MZM.

FIG. 5(c) illustrates a situation in which the received light 218 amplified in the optical amplification unit 208 and the local oscillating light of which frequency is shifted by the optical frequency shifter unit 212 are mixed to be converted into the baseband modulation signal, in the coherent receiving unit 209 of the receiver. The baseband modulation signal is received so as to be within the receiving band. At this time, the third order harmonic component generated in the optical frequency shifter unit 212 is eliminated.

Each of FIG. 5(d) to FIG. 5(f) is a diagram illustrating a case of receiving the signal light emitted from the transmitter of the satellite moving away from an earth station. The frequency shift +Δf in FIG. 5(a) to FIG. 5(c), which illustrate a case where the satellite approaches the earth station, is replaced into −Δf in FIG. 5(d) to FIG. 5(f).

That is, FIG. 5(d) shows a situation where the frequency fs of the signal light emitted from the transmitter of the satellite moving away from the earth station is subject to a frequency shift −Δf by Doppler shift and the like, and becomes fs−Δf.

Further, FIG. 5(e) shows the frequency of the local oscillating light in the receiver 206 when receiving the signal light emitted from the transmitter of the satellite moving away from the earth station.

Moreover, FIG. 5(f) shows a situation in which the receiving light output from the optical amplification unit 208 and the local oscillating light output from the optical frequency shifter unit 212 are mixed to generate the baseband modulation signal, in the coherent receiving unit 209 of the receiver.

As described above, in the optical communication system of the second exemplary embodiment, the frequency of the light source of the transmitter and the frequency of the local oscillating light source of the receiver are separated from each other by the frequency offset. Then, the frequency offset is generated so as to become larger than the sum of the data modulation band and the frequency shift amount in the receiver. As a result, in the optical communication system of the second exemplary embodiment, it is possible to reduce the deterioration in the optical signal to noise ratio due to the harmonic component generated in the optical frequency shifter unit of the receiver.

Further, even in the second exemplary embodiment, similar to the first exemplary embodiment, in a case of setting the band width (total width) of the data signal to W, the frequency offset amount may be set to W/4 or more. If the frequency offset amount is set to at least W/4 or more, the third order harmonic component generated in the optic frequency shifter unit and the frequency component of the data signal do not overlap. Accordingly, even in a case of setting the frequency offset amount to W/4 or more, the same effect as the above is achieved.

Further, the optical communication system of the second exemplary embodiment shifts the signal light carrier frequency in order to cancel the frequency shift generated based on the movement of the mobile object. For this reason, in the optical communication system of the second exemplary embodiment, it is possible to reduce the frequency difference between the receiving light and the local oscillating light generated based on the movement of the mobile object. As a result, in the optical communication system of the second exemplary embodiment, it is possible to more correctly detect the phase of the symbol of the receiving data without oversampling.

As described above, similar to the optical communication system of the first exemplary embodiment, even the optical communication system of the second exemplary embodiment shows an effect of improving the communication quality of the communication system. Further, in comparison with the configuration in which the phase compensation accuracy of the receiving data is improved with performing oversampling, the optical communication system of the second exemplary embodiment can reduce the processing amount of digital signal processing. As a result, the optical communication system of the second exemplary embodiment shows an effect that it is possible to reduce the size of the digital signal processing circuit and to intend to reduce the power consumption of the digital signal processing circuit of the receiver.

Note that, in the optical communication system shown in FIG. 4, the receiver 206 includes only a coherent receiving unit 209, an optical frequency shifter unit 212, a local oscillating light source 211 and a frequency offset control unit 214, and the output of the frequency offset control unit 214 may be directly input to the optical frequency shifter unit 212. In this case, the frequency offset control unit 214 controls the optical frequency shifter unit 212 and shifts the signal light carrier frequency so as to cancel the frequency shift generated based on the movement of the mobile object. As a result, even the receiver 206 including only the coherent receiving unit 209, the optical frequency shifter unit 212, the local oscillating light source 211 and the frequency offset control unit 214 can achieve the same effect as the aforementioned second exemplary embodiment.

### Third Exemplary Embodiment

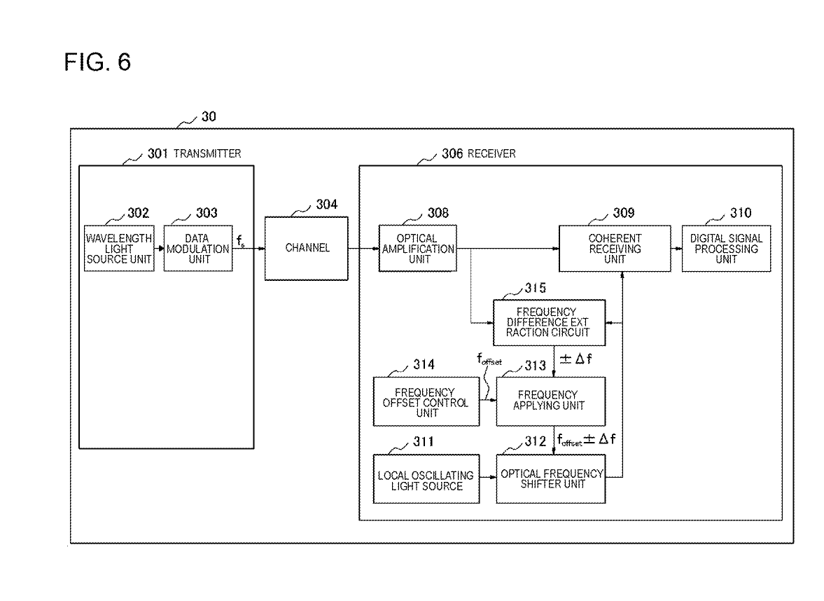

FIG. 6 is a diagram illustrating a configuration of an optical communication system of a third exemplary embodiment of the present invention. The optical communication system 30 includes a channel 304 in which the dynamic shift of a signal carrier frequency occurs, and a transmitter 301 and a receiver 306 in which a digital coherent transmission-reception method is applied.

The optical communication system 30 shown in FIG. 6 includes a frequency difference extraction circuit 315, instead of the frequency shift amount calculation unit 215 and the position information calculation unit 216 described in FIG. 4.

The amount of the frequency shift that the signal light carrier is subject to while propagating through the channel 304 varies at any time from the start of receiving until to the end of receiving according to the change in the relative speed between the transmitter and the receiver.

In the optical communication system 30, instead of the configuration in which the frequency shift is performed based on the position information, the optical frequency shifter unit 312 is controlled such that the frequency of the local oscillating light output from the optical frequency shifter unit 312 follows the optical carrier frequency of the received light. As a result, in the optical communication system 30, in comparison with a case where the frequency shift amount is calculated from the position information, it is possible to more accurately correct the frequency shift amount.

The received signal light and the local oscillating light output from the optical frequency shifter unit 312 are input to the frequency difference extraction circuit 315. The frequency difference extraction circuit 315 detects the frequency difference (that is, frequency shift amount) of the received signals, and output it to the frequency applying unit 313.

The frequency difference detected in the frequency difference extraction circuit 315 is applied to the optical frequency shifter unit 312 through the frequency applying unit 313 and is controlled so as to be small.

Here, the frequency difference extraction circuit 315 may be configured such that the frequency difference is converted to the harmonic beat signal in the balanced detector and the like, and then the frequency difference is detected in the phase synchronization loop circuit.

Further, instead of the local oscillating light source 311 and the optical frequency shifter unit 312, a frequency variable light emitting device such as a mode synchronization semiconductor laser may be used. Then, it may be configured such that the output frequency of the mode synchronization semiconductor laser is directly controlled using the output of the frequency applying unit 313, and the output of the mode synchronization semiconductor laser is input to the coherent receiving unit 309 and the frequency difference extraction circuit 315.

As described above, in the optical communication system of the third exemplary embodiment, the optical frequency shifter unit is controlled such that the frequency of the local oscillating light output from the optical frequency shifter unit follows the frequency of the optical carrier of the received light. As a result, the optical transmission system of the third exemplary embodiment shows the same effect as the optical transmission system of the second exemplary embodiment and further can build the digital coherent transceiving method in which the frequency shift amount is more accurately corrected.

### Fourth Exemplary Embodiment

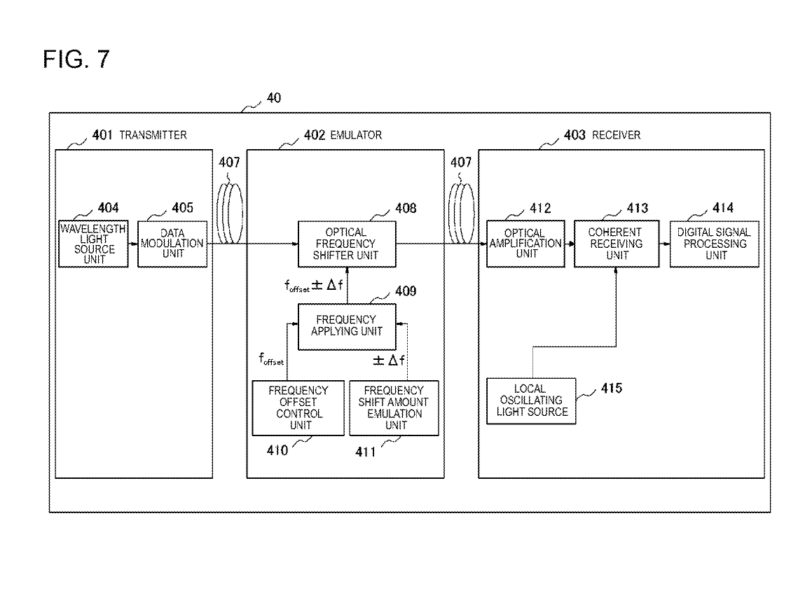

FIG. 7 is a diagram illustrating a configuration of an emulation system 40 of a fourth exemplary embodiment of the present invention. The emulation system 40 includes a transmitter 401 and a receiver 403 to which the digital coherent optical communication method is applied, and an emulator 402 which pseudo generates the frequency shift amount generated through the optical space propagation communication.

To verify the effect of frequency shift affecting the communication system is important, in particular, in the construction of the free-space optical communication technology using a digital coherent method. Then, in order to generate the frequency shift occurred at the time of free-space optical communication with a mobile object such as a satellite, it is necessary to move the mobile object at high speed in which the transmitter is installed. However, it is not possible to generate a frequency shift around ±10 GHz that is generated when a low orbit satellite moves, even using a vehicle or an aircraft as the mobile object. The fourth exemplary embodiment provides an emulation system which emulates a frequency shift in a case where the transmitter moves at high speed.

The transmitter 401 in the emulation system 40 shown in FIG. 7 is configured such that the optical frequency shifter unit 104, the frequency applying unit 105 which is a drive unit thereof, the frequency offset control unit 106, and the frequency shift amount calculation unit 107 are separated from the transmitter 101 and formed as an emulator 402 in the transmitter 101 described in FIG. 3.

The frequency shift amount calculation unit 107 and the position information calculation unit 108 described in FIG. 3 are described as the frequency shift amount emulation unit 411 in FIG. 7. The frequency shift amount emulation unit 411 outputs the signal corresponding to any frequency shift amount ±Δf at any time to the frequency applying unit 409. The operations of the optical frequency shifter unit 408, the frequency applying unit 409 and the frequency offset control unit 410 in FIG. 7 are the same as the operations of the optical frequency shifter unit 104, the frequency applying unit 105 and the frequency offset control unit 106 in FIG. 3, respectively, thus the detailed description thereof will be omitted.

The transmitter 401 and the emulator 402, and the emulator 402 and the receiver 403 are respectively connected with the optical transmission path 407. The optical transmission path 407 is, for example, an optical fiber or a spatial light transmission path. The above configuration enables the emulation system 40 to emulate the frequency shift of the signal light. As a result, the emulation system 40 of the fourth exemplary embodiment enables a performance evaluation of the optical communication system under an environment where frequency shift occurs without providing a fast moving object.

In addition, in the emulation system 40 shown in FIG. 7, the transmitter 401 may be replace with the transmitter 101 described in FIG. 3. With the configuration in which the transmitter 401 is replaced with the transmitter 101, it is possible to perform the emulation of an operation of compensating the frequency shift, which is given by the emulator 402, in the optical frequency shifter unit 104 included in the transmitter 101 in advance.

Alternatively, in the emulation system 40 shown in FIG. 7, the receiver 403 may be replaced with the receiver 206 described in FIG. 4 or the receiver 306 described in FIG. 6. With the configuration in which the receiver 403 is replaced with the receiver 206 or 306, it is possible to emulate the operation in which the receiver 206 or 306 compensates the frequency shift that the optical signal is given by the optical frequency shifter unit 408 included in the emulator 402.

As described above, according to the emulation system of the fourth exemplary embodiment, it is possible to easily make receiving light in which the effect of the frequency shift, which the transmitted light from the fast moving mobile object is given, is emulated, and thus to simplify the performance evaluation of the optical communication system and to reduce the cost thereof.

### Fifth Exemplary Embodiment

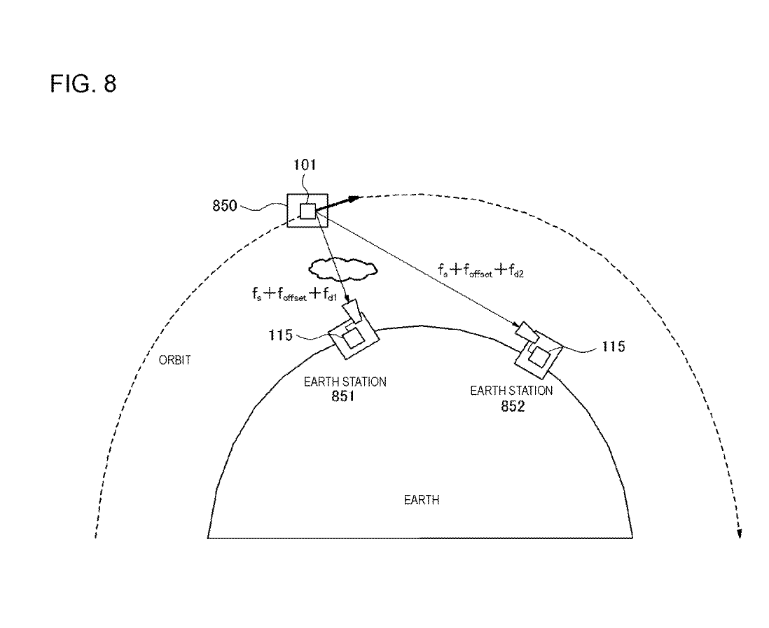

FIG. 8 is a diagram illustrating a handover method of a communication between a satellite and an earth station as a fifth exemplary embodiment of the present invention. In FIG. 8, the transmitter 101 described in FIG. 3 is installed in the satellite 850 and the receiver 115 is installed in the earth station 851 and the earth station 852.

Suppose that, at first, the communication link from the satellite 850 to the earth station 851 is set at the signal carrier frequency of fs+foffset+fd1. Here, fd1 is the frequency shift amount that is calculated from the position information of the satellite 850 and the earth station 851.

In a case where the light is attenuated because of the influence of clouds and the like and thus the communication link from the satellite 850 to the earth station 851 is shut down, in order to ensure an alternative line, it is necessary for the satellite 850 to rapidly recover the failure by handovering the link line to another earth station 852.

An optical frequency shift amount control at the time of handovering the link line from the satellite 850 to the earth station 851 to the link line from the satellite 850 to the earth station 852 will be described using FIG. 8.

In a case where the communication link to the earth station 851 is shut down, the satellite 850 immediately estimates and calculates the frequency shift amount fd2 to the earth station 852. Then, the satellite 850 shifts data such that the frequency is substantially equal to the frequency of the local oscillating light of the earth station 852 with taking into account the optical frequency shift and the offset frequency of the frequency shift amount that is in advance estimated and calculated in the optical frequency shifter unit installed in the transmitter, and transmits the shifted data. This enables to make the frequency difference at the time of reception small in the earth station 852 that is a handover target.

Further, there is a possibility that the frequencies of the local oscillating light sources included in the receivers of the earth station 851 and the earth station 852 are largely different. In this case, the transmitter of the satellite 850 may change the value of the frequency offset foffset such that the frequency difference between the local oscillating light and the received light in the receiver of the earth station 852 becomes within a predetermined range.

In this manner, in the hand over method of the fifth exemplary embodiment, in a case where the communication link to a certain earth station is shut down, the satellite immediately calculates the frequency shift amount for an alternative earth station. Then, the satellite shifts data such that the frequency is substantially equal to the frequency of the local oscillating light of the earth station with taking into account the optical frequency shift and the offset frequency of the calculated frequency shift amount, and transmits the shifted data. As a result, in the handover method of the fifth exemplary embodiment, handover of the line can be performed in a short time when a failure occurs.

This application claims a priority to Japanese patent application No. 2011-67698 filed on Mar. 25, 2011, and the disclosure thereof is incorporated herein.

1. A transmitter comprising:
an optical data modulation unit which modulates an optical carrier having a first frequency with a data signal and outputs the optical carrier as signal light;
an optical frequency shift unit which shifts and outputs the frequency of the signal light from the first frequency to a second frequency based on a predetermined frequency offset amount; and
a frequency offset control unit which controls the frequency offset amount such that a harmonic component generated in the optical frequency shift unit does not overlap with a band of the data signal.

2. The transmitter according to claim 1,
wherein the frequency offset control unit controls such that the frequency offset amount is one fourth or more of whole band width of the data signal.

3. The transmitter according to claim 1, further comprising:
a frequency shift amount calculation unit which outputs a dynamic frequency shift amount to be applied to the signal light in a propagation path of the signal light,
wherein the optical frequency shift unit shifts the frequency of the signal light from the first frequency to the second frequency based on the frequency offset amount and the dynamic frequency shift amount.

4. A communication system comprising:
the transmitter according to claim 1; and
a receiver which receives signal light that the transmitter transmits and coherently receives the signal light using a local oscillating light.

5. A receiver comprising:
a receiving unit which receives signal light that is an optical carrier having a second frequency and modulated with a data signal;
an optical frequency shift unit which shifts and outputs the frequency of local oscillating light having a third frequency to the second frequency based on a predetermined frequency offset amount;
a frequency offset control unit which controls the frequency offset amount such that a harmonic component generated in the optical frequency shift unit does not overlap with a band of the data signal; and
a coherent receiving unit which performs coherent reception using the signal light and the local oscillating light output from the frequency shift unit.

6. The receiver according to claim 5,
wherein the frequency offset control unit controls such that the frequency offset amount is one fourth or more of whole band width of the data signal.

7. The receiver according to claim 5, further comprising:
a frequency shift amount calculation unit which calculates a frequency shift amount from a first frequency to the second frequency of the signal light in a propagation path of the signal light,
wherein the optical frequency shift unit shifts and outputs the frequency of the local oscillating light to the second frequency based on the frequency offset amount and the frequency shift amount.

8. A communication system comprising:
a transmitter including an optical data modulation unit which modulates an optical carrier having a first frequency with a data signal and outputs the optical carrier as a signal light; and
the receiver according to claim 5 that is adapted to receive signal light that the frequency of the optical carrier is shifted from the first frequency to the second frequency.

9. A transmission method comprising:
modulating an optical carrier having a first frequency with a data signal and outputting the optical carrier as signal light;
shifting and outputting the frequency of the signal light from the first frequency to a second frequency based on a predetermined frequency offset amount; and
controlling the frequency offset amount such that a harmonic component generated at the time of shift to the second frequency does not overlap with a band of the data signal.

10. A reception method comprising:
receiving the signal light having a second frequency, that is modulated with a data signal;
shifting and outputting the frequency of local oscillating light having a third frequency to the second frequency based on a predetermined frequency offset amount;
controlling the frequency offset amount such that a harmonic component generated at the time of shift to the second frequency does not overlap with a band of the data signal; and
performing coherent reception using the signal light and the local oscillating light shifted to the second frequency.

11. The transmitter according to claim 2, further comprising:
a frequency shift amount calculation unit which outputs a dynamic frequency shift amount to be applied to the signal light in a propagation path of the signal light,
wherein the optical frequency shift unit shifts the frequency of the signal light from the first frequency to the second frequency based on the frequency offset amount and the dynamic frequency shift amount.

12. A communication system comprising:
the transmitter according to claim 2; and
a receiver which receives signal light that the transmitter transmits and coherently receives the signal light using a local oscillating light.

13. A communication system comprising:
the transmitter according to claim 3; and
a receiver which receives signal light that the transmitter transmits and coherently receives the signal light using a local oscillating light.

14. A communication system comprising:
the transmitter according to claim 11; and
a receiver which receives signal light that the transmitter transmits and coherently receives the signal light using a local oscillating light.

15. The receiver according to claim 6, further comprising:
a frequency shift amount calculation unit which calculates a frequency shift amount from a first frequency to the second frequency of the signal light in a propagation path of the signal light,
wherein the optical frequency shift unit shifts and outputs the frequency of the local oscillating light to the second frequency based on the frequency offset amount and the frequency shift amount.

16. A communication system comprising:
a transmitter including an optical data modulation unit which modulates an optical carrier having a first frequency with a data signal and outputs the optical carrier as a signal light; and
the receiver according to claim 6 that is adapted to receive signal light that the frequency of the optical carrier is shifted from the first frequency to the second frequency.

17. A communication system comprising:
a transmitter including an optical data modulation unit which modulates an optical carrier having a first frequency with a data signal and outputs the optical carrier as a signal light; and
the receiver according to claim 7 that is adapted to receive signal light that the frequency of the optical carrier is shifted from the first frequency to the second frequency.
